(19) United States
(12) Patent Application Publication
(10) Pub. No.: US 2012/0084335 A1
(43) Pub. Date: Apr. 5, 2012

(54) METHOD AND APPARATUS OF PROCESSING FLOATING POINT NUMBER

(76) Inventor: Hung-Ching Chen, Tainan County (TW)

(21) Appl. No.: 12/896,908

(22) Filed: Oct. 3, 2010

(51) Int. Cl. G06F 7/483; G06F 7/552

(52) U.S. Cl. 708/204

(57) ABSTRACT

A method and apparatus of processing floating point number(s) is provided. The method which processes a plurality of first floating point numbers each having a mantissa and an exponent includes: normalizing exponents of the first floating point numbers according to a minimum value of the exponents to generate normalized exponents of the first floating point numbers; generating a plurality of second floating point numbers respectively corresponding to the first floating point numbers according to mantissas and the normalized exponents of the first floating point numbers; utilizing a processor to perform a specific computation on the second floating point numbers to generate a plurality of third floating point numbers; and de-normalizing each of the normalized exponents to accordingly generate a de-normalization result and adjusting the third floating point numbers according to the de-normalization result.

### BACKGROUND OF THE INVENTION

1. Field of the Invention

The present invention relates to floating-point arithmetic, and more particularly to, a method and a related apparatus which are capable of improving the precision of a fixed-point processor processing floating point numbers.

2. Description of the Prior Art

In computing, floating point arithmetic is widely used in graphic, audio, engineering and mathematic applications. However, in some systems such as an embedded system, the processor (e.g. digital signal processor, DSP) does not have the capability of floating point arithmetic; instead, the processor may only have the capability of fixed point arithmetic.

When a fixed-point processor processes a floating point number, the floating point number has to be represented in a fixed-point form. If the number of limited bits of an operand supported by the fixed-point processor is smaller than the number of the bits of the floating point number, a precision loss problem may be encountered. For example, a floating number of 10 bits is 1.1011101×2⁽⁻¹⁰⁰⁾ (represented with IEEE Standard 754), and a fixed-point processor only has an 8-bit-long operand. In this case, a portion of bits of the mantissa 1011101 of the floating number will be discarded since the floating number is represented as 0.0001011101 in a fixed-point form and the number of bits of this fixed-point form is greater than the number of bits of the operand of the fixed-point processor.

Hence, there is a precision loss problem in the conventional art which needs to be solved.

### SUMMARY OF THE INVENTION

With this in mind, it is one objective of the present invention to provide a method and a related apparatus in order to solve the precision loss problem when a fixed-point processor's operand has a limited number of bits smaller than the number of bits of a floating point number to be processed.

In particular, the present invention normalizes/adjusts the exponent of the floating point number before the floating point number is sent to be processed by the fixed-point processor. Then, after the floating point number is processed, the present invention de-normalizes/adjusts the normalized/adjusted exponent of the processed floating point number.

According to one exemplary embodiment of the present invention, a method of processing a plurality of first floating point numbers each having a mantissa and an exponent is provided. The method comprises: normalizing exponents of the first floating point numbers according to a minimum value of the exponents to generate normalized exponents of the first floating point numbers; generating a plurality of second floating point numbers respectively corresponding to the first floating point numbers according to mantissas and the normalized exponents of the first floating point numbers; utilizing a processor to perform a specific computation on the second floating point numbers to generate a plurality of third floating point numbers; and de-normalizing each of the normalized exponents to accordingly generate a de-normalization result and adjusting the third floating point numbers according to the de-normalization result.

According to another exemplary embodiment of the present invention, an apparatus of processing a plurality of first floating point numbers each having a mantissa and an exponent is provided. The apparatus comprises: a normalization circuit, a floating point number generation circuit, a processor, and a de-normalization circuit. The normalization circuit is configured for normalizing exponents of the first floating point numbers according to a minimum value of the exponents to generate normalized exponents of the first floating point numbers. The floating point number generation circuit is coupled to the normalization circuit and configured for generating a plurality of second floating point numbers respectively corresponding to the first floating point numbers according to mantissas and the normalized exponents of the first floating point numbers. The processor is coupled to a floating point number generation circuit and configured for performing a specific computation on the second floating point numbers to generate a plurality of third floating point numbers. The de-normalization circuit is coupled to the processor and configured for de-normalizing each of the normalized exponents to accordingly generate a de-normalization result and adjusting the third floating point numbers according to the de-normalization result.

According to still another exemplary embodiment of the present invention, a method of processing a floating point numbers having a mantissa and an exponent is provided. The method comprises: adjusting the exponent of the floating point number according to a specific value; generating an adjusted floating point number corresponding to the floating point number according to the mantissas and the adjusted exponent of the first floating point number; utilizing a processor to perform a specific computation on the adjusted floating point number to generate a processed floating point number; and adjusting the processed floating point number by adjusting an exponent of the processed floating number according to the specific value.

According to yet another exemplary embodiment of the present invention, an apparatus of processing a floating point numbers having a mantissa and an exponent is provided. The apparatus comprises: a first adjustment circuit, a second circuit, a floating point number generation circuit and a processor. The first adjustment circuit is configured for adjusting the exponent of the floating point number according to a specific value. The floating point number generation circuit is coupled to the first adjustment circuit and configured for generating an adjusted floating point number corresponding to the floating point number according to the mantissas and the adjusted exponent of the first floating point number. The processor is coupled to the floating point number generation circuit and configured for performing a specific computation on the adjusted floating point number to generate a processed floating point number. The second adjustment circuit is coupled to the processor and configured for adjusting the processed floating point number by adjusting an exponent of the processed floating number according to the specific value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart according to one exemplary embodiment of the inventive method.

FIG. 2 is a flow chart according to another exemplary embodiment of the inventive method.

FIG. 3 is a block diagram according to one exemplary embodiment of the invention apparatus.

FIG. 4 is a block diagram according to another exemplary embodiment of the invention apparatus.

### DETAILED DESCRIPTION

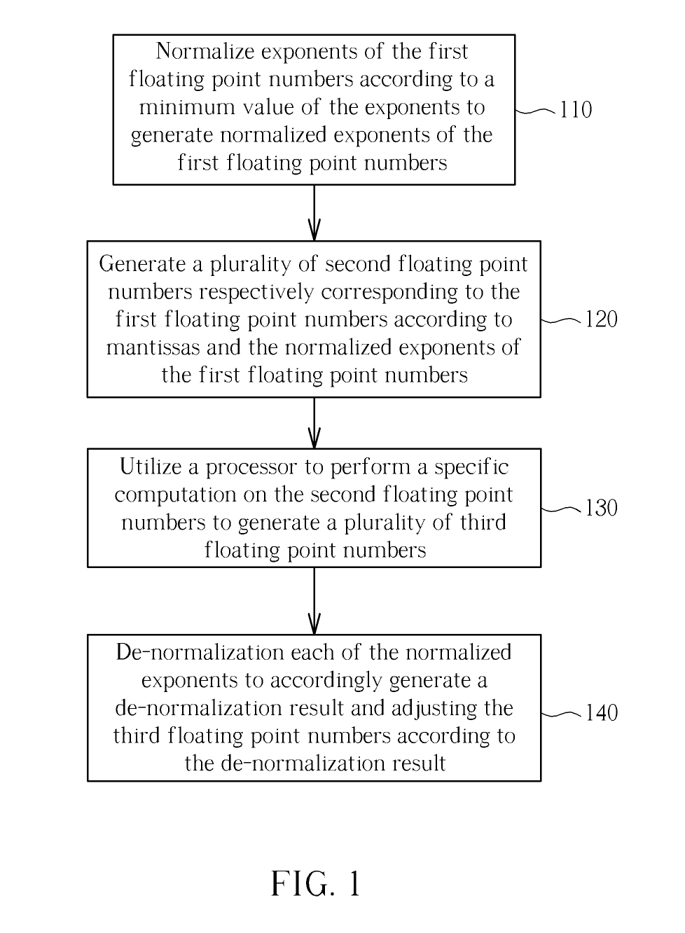

Please refer to FIG. 1, which illustrates a flow chart according to one exemplary embodiment of the inventive method. The inventive method processes a plurality of first floating point numbers each having a mantissa and an exponent. As shown in FIG. 1, step 110 normalizes exponents of the first floating point numbers according to a minimum value of the exponents to generate normalized exponents of the first floating point numbers. In particular, step 110 generates the normalized exponents of the first floating point numbers by subtracting the minimum value from the exponents of first floating point numbers. For example, if the exponents of the first floating point numbers are: {3, 4, 2, 5, 7, 6, 4, 3, 4, 6, 10, 9}, the minimum value of the exponents will be 2, and the normalized exponents of the first floating point numbers will be: {1, 2, 0, 3, 5, 4, 2, 1, 2, 4, 8, 7}. Accordingly, step 120 generates a plurality of second floating point numbers respectively corresponding to the first floating point numbers according to mantissas (original) and the normalized exponents {1, 2, 0, 3, 5, 4, 2, 1, 2, 4, 8, 7} of the first floating point numbers.

When the second floating point numbers are represented in a fixed-point form, radix points in the mantissas of second floating point numbers need to be shifted according to the exponents. Compared to the first floating point numbers, the exponents of the second floating point numbers are uniformly reduced. Hence, the radix points in the mantissas are shifted by fewer bits, and less data will be discarded by the processor whose operand has a fewer number of bits.

In step 130, a processor is utilized for performing a specific computation on the second floating point numbers to generate a plurality of third floating point numbers. Accordingly, step 140 de-normalizes each of the normalized exponents to accordingly generate a de-normalization result and adjusts the third floating point numbers according to the de-normalization result. In particular, if the exponents of the first floating number are uniformly reduced by 2 after normalization, in the de-normalization process of step 140, the value of 2 will be respectively applied (e.g. added) to exponents of the third floating numbers generated by the processing of the processor where the processor may be a fixed-point processor. This invention is especially suitable for audio applications such as Dolby Digital audio decoding architecture. In this architecture, encoded data comprising a block of 256/512 frequency samples need to be transformed from the frequency domain to the time domain by a processor. Hence, if a low-end fixed-point processor (whose operand has a fewer number of bits) is adopted in this decoding architecture, the inventive method can prevent the precision loss problem.

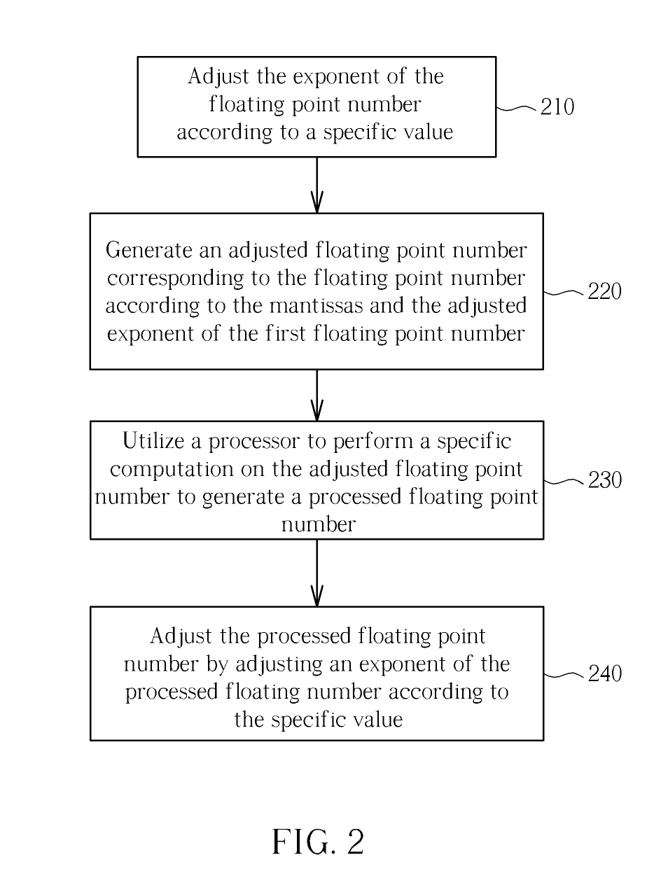

In addition, the present invention is also feasible for processing a single floating point number. For a single floating point number, the inventive method may adjust an exponent of the floating point number by subtracting a specific value from the exponent to make the adjusted exponent as small as possible. In a preferred case, the adjustment makes the adjusted exponent 0. That is, the specific value varies with and is proportional to the exponent of the floating point number. Then, an adjusted floating point number is generated according to the mantissa and the adjusted exponent of the floating point number and then processed by a processor. After processing, a processed floating point number is accordingly generated and an exponent of the processed floating point number will be adjusted according to the specific value. Thus, the precision loss problem can be avoided. A corresponding flow chart is illustrated in FIG. 2.

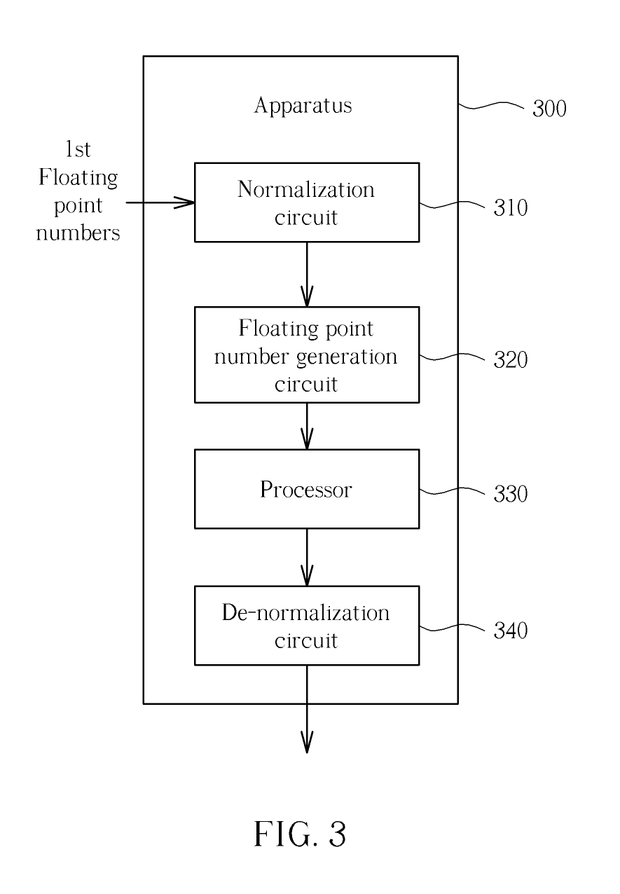

Please refer to FIG. 3, which illustrates a block diagram of an inventive apparatus according to one exemplary embodiment of the present invention. The apparatus is configured for processing a plurality of first floating point numbers each having a mantissa and an exponent is. As shown in FIG. 2, the apparatus 300 comprises (but is not limited to): a normalization circuit 310, a floating-point number generation circuit 320, a processor 330, and a de-normalization circuit 340. The normalization circuit 310 is configured for normalizing exponents of the first floating point numbers according to a minimum value of the exponents to generate normalized exponents of the first floating point numbers. In particular, the normalization circuit 310 generates the normalized exponents of the first floating point numbers by subtracting the minimum value from the exponents of first floating point numbers. The floating point number generation circuit 320 is coupled to the normalization circuit and configured for generating a plurality of second floating point numbers respectively corresponding to the first floating point numbers according to mantissas and the normalized exponents of the first floating point numbers. The processor 330 is coupled to a floating point number generation circuit and configured for performing a specific computation on the second floating point numbers to generate a plurality of third floating point numbers. The de-normalization circuit 340 is coupled to the processor and configured for de-normalizing each of the normalized exponents to accordingly generate a de-normalization result and adjusting the third floating point numbers according to the de-normalization result. Since the conception of the inventive apparatus is similar to the conception of the inventive method, detailed descriptions about operations of elements of the inventive apparatus can be derived by referring to descriptions concerning the inventive method.

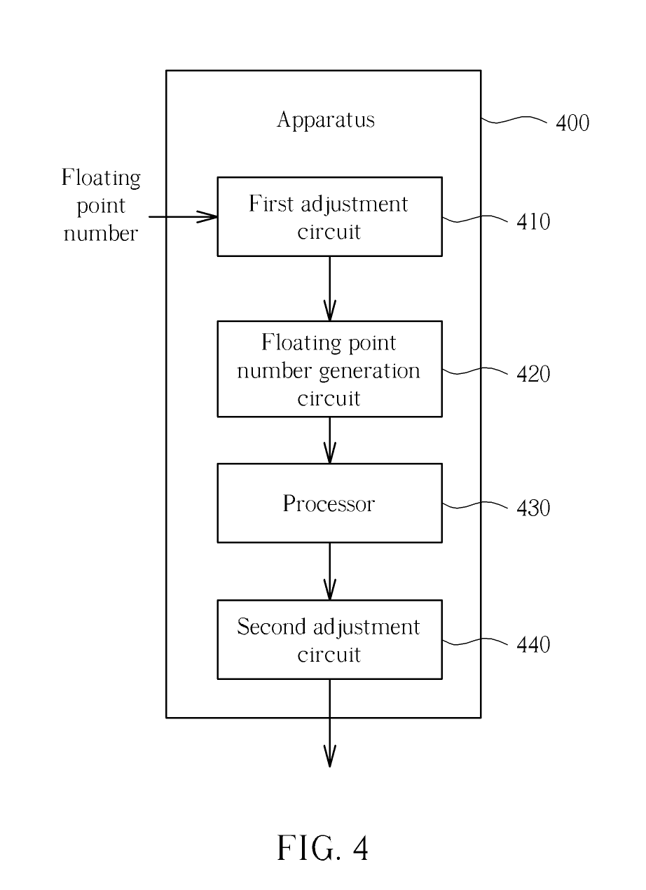

The invention also provides an apparatus for processing a single floating number. Please refer to FIG. 4, which illustrates a block diagram of an apparatus of processing a floating point number having a mantissa and an exponent according to an exemplary embodiment of the present invention. As shown in FIG. 4, the apparatus 400 comprises (but is not limited to): a first adjustment circuit 410 configured for adjusting the exponent of the floating point number according to a specific value; a floating point number generation circuit 420 coupled to the first adjustment circuit and configured for generating an adjusted floating point number corresponding to the floating point number according to the mantissas and the adjusted exponent of the first floating point number; a processor 430 coupled to the floating point number generation circuit and configured for performing a specific computation on the adjusted floating point number to generate a processed floating point number; and a second adjustment circuit 440 coupled to the processor and configured for adjusting the processed floating point number by adjusting an exponent of the processed floating number according to the specific value. In particular, the first adjustment circuit 410 may subtract the specific value from the exponent of the floating point number. The specific value is proportional to and varies with the exponent of the floating point number to make the adjusted exponent as small as possible. In a preferred case, the first adjustment circuit 410 makes the adjusted exponent 0. Furthermore, the second adjustment circuit 440 adds the specific value to an exponent of the processed floating number.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment. Thus, although embodiments have been described in language specific to structural features and/or methodological acts, it is to be understood that claimed subject matter may not be limited to the specific features or acts described.

Rather, the specific features and acts are disclosed as sample forms of implementing the claimed subject matter.

In conclusion, the present invention avoids the precision loss problem by relieving the shifting of the radix point (that is, the radix point is shifted by fewer bits) when a floating point number is represented in a fixed-point form. This approach is achieved by normalizing/adjusting the exponent of the floating number before the floating number is processed by the fixed-point processor.

Those skilled in the art will readily observe that numerous modifications and alterations of the device and method may be made while retaining the teachings of the invention.

What is claimed is:

1. A method of processing a plurality of first floating point numbers each having a mantissa and an exponent, comprising:
normalizing exponents of the first floating point numbers according to a minimum value of the exponents to generate normalized exponents of the first floating point numbers;
generating a plurality of second floating point numbers respectively corresponding to the first floating point numbers according to mantissas and the normalized exponents of the first floating point numbers;
utilizing a processor to perform a specific computation on the second floating point numbers to generate a plurality of third floating point numbers; and
de-normalizing each of the normalized exponents to accordingly generate a de-normalization result and adjusting the third floating point numbers according to the de-normalization result.

2. The method of claim 1, wherein the step of normalizing the exponents of the first floating point numbers comprises:
generating the normalized exponents of the first floating point numbers by subtracting the minimum value from the exponents of first floating point numbers.

3. The method of claim 1, wherein the specific computation is a frequency-to-time transform.

4. The method of claim 1, wherein the processor is a fixed-point processor.

5. The method of claim 1, wherein the first floating point numbers include a plurality of frequency samples complying with a Dolby Digital audio coding standard.

6. An apparatus of processing a plurality of first floating point numbers each having a mantissa and an exponent, comprising:
a normalization circuit, for normalizing exponents of the first floating point numbers according to a minimum value of the exponents to generate normalized exponents of the first floating point numbers;
a floating point number generation circuit coupled to the normalization circuit, for generating a plurality of second floating point numbers respectively corresponding to the first floating point numbers according to mantissas and the normalized exponents of the first floating point numbers;
a processor coupled to a floating point number generation circuit, for perform a specific computation on the second floating point numbers to generate a plurality of third floating point numbers; and
a de-normalization circuit coupled to the processor, for de-normalizing each of the normalized exponents to accordingly generate a de-normalization result and adjusting the third floating point numbers according to the de-normalization result.

7. The apparatus of claim 6, wherein the normalization circuit generates the normalized exponents of the first floating point numbers by subtracting the minimum value from the exponents of first floating point numbers.

8. The apparatus of claim 6, wherein the specific computation is a frequency-to-time transform.

9. The apparatus of claim 6, wherein the processor is a fixed-point processor.

10. The apparatus of claim 6, wherein the first floating point numbers include a plurality of frequency samples complying with a Dolby Digital audio coding standard.

11. A method of processing a floating point numbers having a mantissa and an exponent, comprising:
adjusting the exponent of the floating point number according to a specific value;
generating an adjusted floating point number corresponding to the floating point number according to the mantissas and the adjusted exponent of the first floating point number;
utilizing a processor to perform a specific computation on the adjusted floating point number to generate a processed floating point number; and
adjusting the processed floating point number by adjusting an exponent of the processed floating number according to the specific value.

12. The method of claim 11, wherein the step of adjusting the exponent of the floating point number comprises:
subtracting the specific value from the exponent of the floating point number, wherein the specific value is proportional to the exponent of the floating number.

13. The method of claim 11, wherein the step of adjusting the processed floating point number comprises:
adding the specific value to an exponent of the processed floating number, wherein the specific value is proportional to the exponent of the floating number.

14. The method of claim 11, wherein the specific computation is a frequency-to-time transform.

15. The method of claim 11, wherein the processor is a fixed-point processor.

16. An apparatus of processing a floating point numbers having a mantissa and an exponent, comprising:
a first adjustment circuit, for adjusting the exponent of the floating point number according to a specific value;
a floating point number generation circuit coupled to the first adjustment circuit, for generating an adjusted floating point number corresponding to the floating point number according to the mantissas and the adjusted exponent of the first floating point number;
a processor coupled to the floating point number generation circuit, for performing a specific computation on the adjusted floating point number to generate a processed floating point number; and
a second adjustment circuit coupled to the processor, for adjusting the processed floating point number by adjusting an exponent of the processed floating number according to the specific value.

17. The apparatus of claim 16, wherein the first adjustment circuit subtracts the specific value from the exponent of the floating point number, and the specific value is proportional to the exponent of the floating point number.

18. The apparatus of claim 16, wherein the second adjustment circuit adds the specific value to an exponent of the processed floating number, and the specific value is proportional to the exponent of the floating point number.

19. The apparatus of claim 16, wherein the specific computation is a frequency-to-time transform.

20. The apparatus of claim 16, wherein the processor is a fixed-point processor.
